(19) United States
(12) Patent Application Publication
(10) Pub. No.: US 2025/0385747 A1
(43) Pub. Date: Dec. 18, 2025

(54) METHOD AND NETWORK NODE FOR LINK ADAPTATION

(71) Applicant: Telefonaktiebolaget LM Ericsson (PUBL), Stockholm (SE)

(72) Inventors: Hazem ELGABROUN, LUND (SE); Irfan BAIG, LUND (SE)

(21) Appl. No.: 18/875,588

(22) PCT Filed: Jun. 30, 2022
(86) PCT No.: PCT/EP2022/068194

§ 371 Date: Dec. 16, 2024

(51) Int. Cl. H04L 1/00; H04L 1/20

(52) U.S. Cl. CPC H04L 1/0003; H04L 1/0009; H04L 1/203

(57) ABSTRACT

The invention relates to a method for performing a link adaptation in an uplink transmission between a user equipment, UE, and a network node in a telecommunication network, the method comprising:
obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and
predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

### TECHNICAL FIELD

The invention relates to a method and a network node, for performing link adaption (LA) for an uplink transmission. Furthermore, a computer program and a computer readable storage medium are also provided herein.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN).

The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNodeB (gNB) as denoted in New Radio (NR), which may also be referred to as 5G. A service area or cell area is a geographical area where radio coverage is provided by the radio network node. The radio network node communicates over an air interface, which may also be referred to as a channel or a radio link, operating on radio frequencies with the wireless device within range of the radio network node.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

Link adaptation in general is the concept of adjusting parameters related to the transmission of some information over a channel, i.e., the “link” which you want to adapt to, in order to meet certain objectives. While it is generally needed in some form in all systems which deal with information transfer, it is particularly challenging in wireless systems as the properties of the channel tends to change at a relatively rapid pace.

A very common objective is to minimize the resource consumption while retaining a certain desired level of robustness and where the resource consumption and robustness are related so that higher resource consumption means higher robustness and vice versa. Two very common examples of this are when the parameter to adjust is either an amount of channel coding (more coding means that more resources are needed to transmit the same amount of information) or a transmit power.

LA in current 5G NR systems depends on look-up tables to decide the suitable Modulation and Coding Scheme (MCS). These tables are built depending on several simulations, which in average results the highest performance of the transmission link. The scheduler chooses the MCS value that corresponds to given measured inputs, mainly Signal to Interference and Noise Ratio (SINR), while satisfying the constraint of keeping the BLER below a certain threshold (10%). However, use of static look-up tables leads to ignoring of significant information related to each cell environment and UE parameters, as well as being highly dependent on the estimated SINR values.

Traditional LA uses certain methods, such as e.g. outer loop and inner loop, to estimate a Signal to Interference plus Noise Ratio (SINR) value representing the wireless channel condition. A Modulation and Coding Scheme (MCS) value which has a fix BLER target is then mapped based on this SINR, in order to keep the correctness of wireless transmission.

In some advanced LA research, high complexity supervised learning methods are used to obtain performance gain.

### SUMMARY

It is an object of embodiments herein to enhance performance of a wireless communications network, in particular by providing a method for handling link adaption of a channel that overcomes one or more of the drawbacks of the prior art.

According to an aspect, the invention relates to a method for performing a link adaptation in an uplink transmission between a user equipment, UE, and a network node in a telecommunication network. The method comprises: obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

In specific embodiments, the method comprises: sending information on the predicted second value of the MCS to the UE.

In specific embodiments, obtaining a first value of the MCS, includes: estimating the SINR on the basis of reference signals transmitted by the UE to the network node.

In specific embodiments, obtaining a first value of the MCS, includes: obtaining the first value of the MCS from look-up tables disclosed in the standard 3GPP TS 38.214.

In specific embodiments, predicting a second value of the MCS for the transmission at transmission time k by using a Q-learning process comprises predicting the value of a variable Δ, wherein Δ is an integer, and the second value for MCS is equal to the sum of the first value of the MCS and Δ or to the difference between the first value of the MCS and Δ. Preferably, the method also comprises selecting a maximum value for Δ; and predicting the value of Δ with the constraint that Δ is smaller or equal to the selected maximum value. The selected maximum value for Δ may depend on a maximum acceptable value for the Block Error Rate, BLER, of the uplink transmission. The maximum value for Δ may be equal to 5.

In specific embodiments, predicting a second value of the MCS for the transmission at transmission time k by using a Q-learning process comprises selecting a reward function for the Q-learning process which depends on a Transfer Block Size, TBS, of a transmission at transmission time j and on the ACK/NACK value of the transmission at transmission time interval j. The reward function may be equal to zero if the ACK/NACK value is equal to NACK.

In specific embodiments, the method includes: obtaining the first data or the second data by obtaining a Hybrid automatic repeat request, HARQ of a transmission that took place at transmission time interval k−1.

In specific embodiments, the method comprises selecting a maximum acceptable value for the Block Error Rate, BLER, of the uplink transmission, and wherein predicting a second value of the MCS for the transmission at transmission time k by using a Q-learning process includes: selecting a minimum value for an exploration rate of the Q-learning process based on the maximum acceptable value for the BLER of the uplink transmission.

In specific embodiments, for a plurality of p transmissions at transmission time intervals k−p, . . . , k−1, the method includes associating to a HARQ process ID of each of the p transmissions of the plurality their corresponding ACK/NACK value.

In specific embodiments, predicting a second value of the MCS for the transmission at transmission time k by using a Q-learning process comprises: selecting a discount factor equal to zero.

In specific embodiments, the uplink transmission is in the frequency range of 24.25 GHZ and 52.6 GHZ.

According to another aspect, the invention relates to a network node performing a link adaptation in an uplink transmission with a user equipment, UE, in a telecommunication network, the network node comprising: a processing circuitry; and a memory coupled with the processing circuitry, wherein the memory includes instructions that when executed by the processing circuitry causes the network node to perform operations, the operations comprising: obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

In specific embodiments, the memory includes instructions that when executed by the processing circuitry causes the network node to perform operations according to the first aspect.

According to another aspect, the invention relates to a network node performing a link adaptation in an uplink transmission with a user equipment, UE, in a telecommunication network, the network node being adapted to: obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

In specific embodiments, the network node is adapted to perform operations according to the first aspect.

In specific embodiments, the network node comprises an access network node.

According to an aspect, the invention relates to a computer program comprising program code to be executed by processing circuitry of a network node operating in a telecommunications network, whereby execution of the program code causes the network node to perform operations, the operations comprising: obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

In specific embodiments, the computer program comprises program code to be executed by processing circuitry of a network node operating in a telecommunications network, whereby execution of the program code causes the network node to perform operations according to the first aspect.

In specific embodiments, the invention relates to a computer program comprising program code to be executed by processing circuitry of a network node operating in a telecommunications network, whereby execution of the program code causes the network node to perform operations according to the first aspect.

In an aspect, the invention relates to a computer program product comprising a non-transitory storage medium including program code to be executed by processing circuitry of a network node operating in a telecommunications network, whereby execution of the program code causes the network node to perform operations, the operations comprising: obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

In specific embodiments, execution of the program code causes the network node to perform operations according to the first aspect.

### BRIEF DESCRIPTION OF THE DRAWINGS

Some of the embodiments contemplated herein will now be described more fully with reference to the accompanying drawings. Embodiments are provided by way of example to convey the scope of the subject matter to those skilled in the art.

FIG. 1 shows an example of a telecommunication system 100 in accordance with some embodiments;

FIG. 2 shows an example of a User Equipment (UE) in accordance with some embodiments;

FIG. 3 shows an example of a network node in accordance with some embodiments;

FIG. 4 shows a detail of FIG. 1;

FIG. 5 shows a flow chart of an embodiment of the method of the invention;

FIG. 6 shows a detail of an embodiment of the method of FIG. 5;

FIG. 7 shows an example of a network node in accordance with some embodiments;

FIGS. 8a and 8b show a graph and a Q-table, respectively, according to an embodiment of a step of the method of the invention;

FIGS. 9a and 9b show a graph and a Q-table, respectively, according to another embodiment of a step the method of the invention;

FIG. 10 is a bar chart illustrating an example of results;

FIG. 11 shows graphs illustrating another example of results;

FIG. 12 is a bar chart illustrating another example of results;

FIG. 13 shows graphs illustrating another example of results; and

FIG. 14 is a bar chart illustrating another example of results.

### DETAIL DESCRIPTION OF EMBODIMENTS

The present invention is applicable to a communication system, such as a telecommunication network.

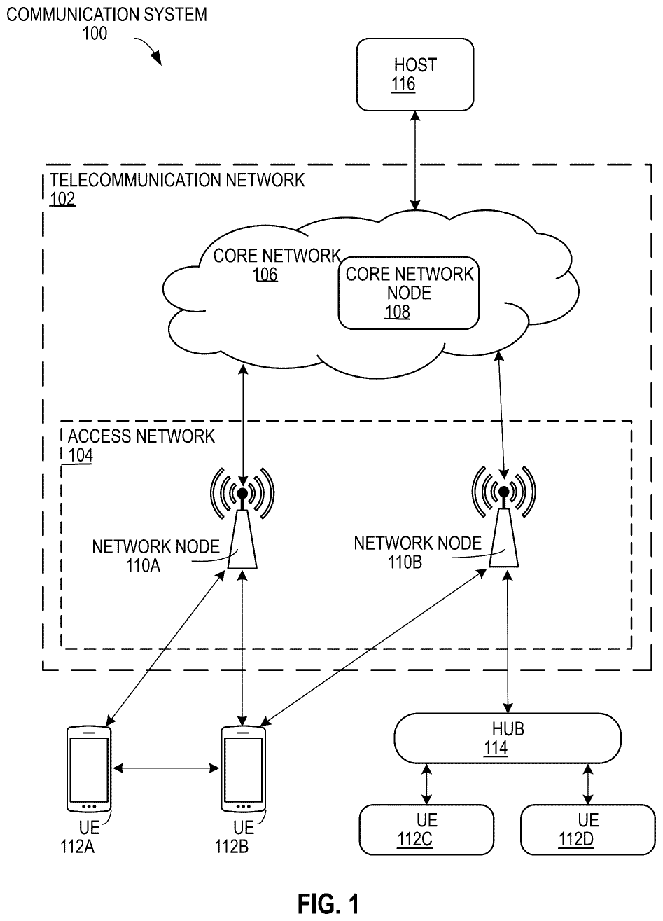

In the example of FIG. 1, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

The network nodes 110 facilitate direct or indirect connection of a user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example of FIG. 1, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, a hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs.

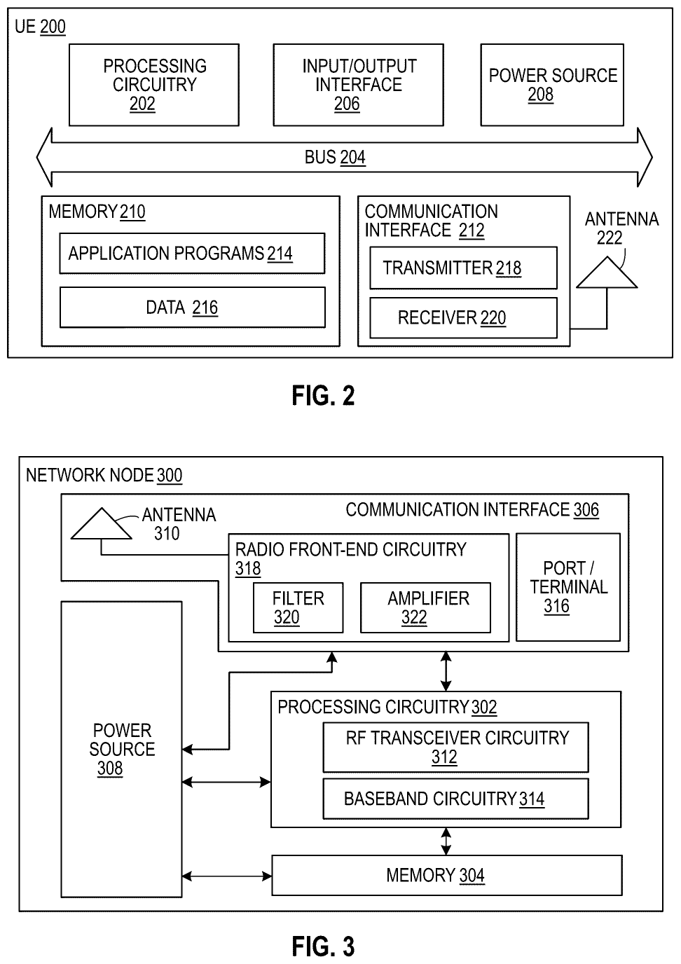

FIG. 2 shows a UE 200 in accordance with some embodiments. UE 200 may be identical to UE 112 of FIG. 1. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

In embodiments, the UE 200 may be an Internet of Things (IoT) device, for example it may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

The UE 200 includes processing circuitry 202. The UE 200 may also include one or more of: an input/output interface 206, a power source 208, a memory 210, a communication interface 212. The processing circuitry may be operatively coupled via a bus 204 to the input/output interface 206, the power source 208, the memory 210, the communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

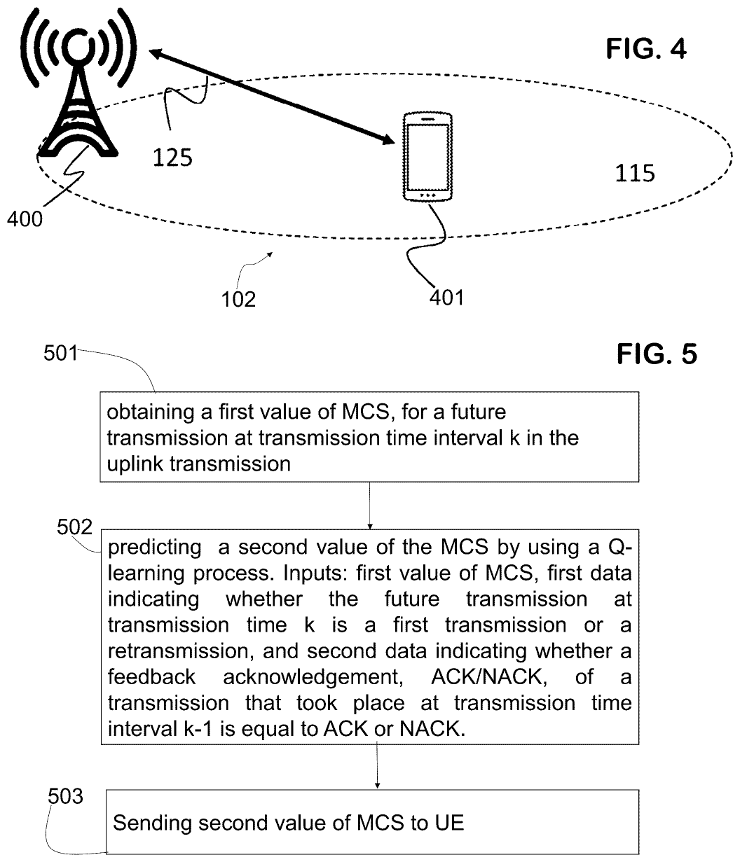

With now reference to FIG. 4, in embodiments, preferably but not necessarily, the telecommunication network 102 is a 5G network including network node 400. The network node 400 may be a network node of an access network, such as network node 110 or 300 of FIG. 1 or 3, respectively, such as e.g. a base station, an eNB or a gNB. One or more UE 401 are connected to the telecommunication network 102 via the network node 400.

The UE 401 is for example the UE 112 or 200 of FIG. 1 or 2 and it may also be referred to as a wireless device. In the following the UE will be designated with number 401 only (and some of its embodiments may be UE 112 or 200). The network node 300 serves a coverage area, also referred to as e.g. a cell 125 or a beam. In general, UEs 401 that are within coverage of the network node 400, such as e.g., within the cell served by network node 400, communicate with the network node 400 by transmitting and receiving wireless signals over a radio channel 125, which may also be referred to as a link. Adjusting parameters related to the transmission of information over the channel, i.e. the “link” which you want to adapt to, in order to meet certain objectives is commonly referred to as Link Adaption (LA). For example, the UE 401 and network node 400 may communicate wireless signals 125 containing voice traffic, data traffic, and/or control signals. When the network node 400 is communicating voice traffic, data traffic, and/or control signals to the UE 112, it may be referred to as a serving network node for the UE 401. The wireless signals 125 may include both downlink transmissions, i.e. from the network node 400 to the UE 401, and uplink transmissions, i.e. from the UE 401 to the network node 400.

The present invention relates to link adaptation applied to the uplink (UL) transmission from the UE 401 to the network node 400.

The network node 400 needs to know about the UE's channel conditions in order to perform scheduling. This may be done using the Channel Quality Indicator (CQI) feedback that the UE 401 calculates based on its downlink Signal to Interference and Noise Ratio (SINR). Once the network node 400 gets the CQI, the network node 400 converts it to a Modulation and Coding Scheme (MCS) and schedule the user on basis of this MCS.

SINR is a relevant parameter because is a measure of signal quality. It can be defined as the ratio of wanted signal strength and the unwanted interference plus noise. SINR may be defined as the ratio between the Signal Power and the (Noise+Interference Power). Good SINR can help to achieve higher spectral efficiency as it enables to decode higher Modulation Coding Scheme (MCS).

For example, the MAC layer is responsible for allocation of uplink physical resources (Resource Blocks) to UE. The MAC also decides the MCS (Modulation and Coding Scheme) and the transmission power used by each UE. The MAC determines the uplink allocation parameters based on the channel quality measurements provided by Physical layer for each of the uplink channel allocations. A common measurement used is CQI (Channel Quality Indicator). CQI is computed by Physical layer using the DMRS reference signals. CQI is a function of the SINR of the uplink received signal post ADC (Analog to digital Conversion).

For the Data Scheduling, there are, in embodiments, two algorithms that work together.

In the UL scenario, the SINR is measured at the network node 400 (e.g. base station), and eventually mapped to the MCS value, using predefined look-up tables that were built using previous simulations. The MCS value is then sent to the UE in the DCI report to be used for transmission. This LA procedure that relies on the look-up tables and estimated SINR is known as inner loop link adaptation (ILLA). However, this procedure is vulnerable to outdated and inaccurate SINR estimated values.

To overcome this issue, an outer loop link adaptation (OLLA) is used. The OLLA can reduce the MCS dependency on the estimated SINR. The present invention focuses on the OLLA.

The starting point is the SINR calculated at the network node 400. As mentioned above, in the UL case, the network node 400 estimates the SINR using the reference signals transmitted by the UE. By applying this estimation, the network node may estimate a first MCS value, which for example can be mapped using look-up tables. These look-up tables are optimized using several simulations with different scenarios.

In known methods, then the chosen first MCS value from the look-up tables is transmitted to the UE to enable correct modulation. Given the MCS, the UE also uses look-up tables to determine the Modulation Order (Qm) and Code Rate (R) to be used in its transmission. An example of these look-up tables can be found for example in 3rd Generation Partnership Project (3GPP) “Physical layer procedures for data (Release 15)”, Technical Specification 38.214, version 15.2.0.2018. The MCS value ranges between 0 and 31 (5 Bits).

In the present invention, an optimization of the first MCS value obtained as above is performed.

According to embodiments, as depicted in FIG. 5, the method for link adaptation for uplink transmission comprises obtaining 501 a first value of a Modulation and Coding Scheme, MCS, for a future transmission at transmission time interval k in the uplink transmission. The method estimates a first value of MCS to be used in the future uplink transmission that takes place at time k.

This first value of MCS is determined on the basis of a Signal to Interference and Noise Ratio, SINR, estimated by the network node 400 for the future transmission at transmission time interval k. For example, this first MCS value is the MCS value described above and mapped using look-up tables by the network node 400. The estimation is preferably performed using reference signals transmitted by the UE 401 to the network node 400. The first value of MCS is obtained using a SINR estimated at the network node 400 at time k−1. As an example, the first MCS for the transmission at transmission time interval k is based or is a function of the SINR estimated using measurement taken at transmission time interval k−1. Thus, for any future transmission at transmission time interval k, a first value of MCS is obtained by the network node. The first MCS value is obtained using measurements communing from the UE taken at transmission time interval k−1.

As an example, obtaining a first value of the MCS includes: obtaining the first value of the MCS from look-up tables disclosed in the standard 3GPP TS 38.214. However, different tables could be used.

In the method, this first value of MCS is preferably not sent directly to the UE 401 (for example using DCI over PDCCH channel) in order to be used in the transmission, but it is further “finely tuned” according to the invention.

The first MCS value obtained in step 501 is one of the inputs of a Q-learning process, the output of which is a second value of MCS. The second value of MCS is the value that is then preferably transmitted to the UE, for example the allocated second value of MCS is signaled to the UE using DCI over PDCCH channel e.g. DCI 1_0, DCI 1_1. Preferably, therefore, the second value of MCS, function of the first value of MCS, is transmitted to the UE so that it can be used for the uplink transmission at transmission time k.

The method of FIG. 5 includes predicting 502 a second value of the MCS for the future transmission at transmission time k. The prediction is taken by using a Q-learning process. The Q-learning process has, as one of the inputs, the first value of MCS.

Further inputs for the Q-learning process are first data indicating whether the future transmission at transmission time k is a first transmission or a retransmission, and second data indicating whether a feedback acknowledgement, ACK/NACK, of a transmission that took place at transmission time interval k−1 is equal to ACK or NACK. The Q learning process thus differentiates whether the transmission at transmission time k is a first transmission of a given packet or the packet needs to be retransmitted. Another input is whether the previous transmission, i.e., the transmission at transmission time k−1, had as a feedback acknowledgement an ACK or a NACK.

Q-learning is a model-free reinforcement learning algorithm to learn the value of an action in a particular state. Machine-learning techniques such as reinforcement learning (RL) are increasingly being used to replace rule-based algorithms. Q-learning depends on a table that stores all previous experience, known as the Q-table. The Q stands for Quality, as it describes the quality of an action at a certain state. This is done by following Bellman's optimality principle, through an iterative process. In other words, after building the Q-table that describes all actions at all states, the agent follows a greedy policy, where it chooses the action that corresponds to the highest Q-value.

In more detail, RL is a decision-making framework in which an agent interacts with an environment by exploring its states and selecting actions to be executed on the environment. Actions are selected with the aim of maximising the long-term return of the actions according to a reward signal. More formally, an RL problem is defined by:
The state space S: which is the set of all possible states in which the environment may exist,
The action space A: which is the set of all possible actions which may be executed on the environment,
The transition probability distribution P: which is the probability of transitioning from one state to another based on an action selected by the agent,
The reward distribution R: which incentivises or penalises specific state-action pairs.

The agent's policy π defines the control strategy implemented by the agent and is a mapping from states to a policy distribution over possible actions, the distribution indicating the probability that each possible action is the most favourable given the current state. An RL interaction proceeds as follows: at each time instant t, the agent finds the environment in a state sₜ ∈S. The agent selects an action aₜ˜π(·|sₜ)∈A, receives a stochastic reward rₜ˜R(·|sₜ,aₜ), and the environment transitions to a new state sₜ₊₁˜P(·|sₜ,aₜ). The agent's goal is to find the optimal policy, i.e. a policy that maximizes the expected cumulative reward over a predefined period of time, also known as the policy value function

$${V}^{π} ( s ) = {𝔼}_{π} [ {\sum }_{i = 0}^{∞} {γ}^{i} {r}_{t + i} \vert {s}_{t} = s ] .$$

The Q-Learning process adjusts the MCS value (first MCS value) estimated by the network node (for example via the look-up tables) to predict a new and more accurate value suitable for the transmission conditions, the second MCS value. It is to be understood that in some cases the second MCS value can be identical to the first MCS value because the first MCS value is already the optimal MCS value to be used in the transmission at transmission time k. The use of second MCS value outputted by the Q-Learning process results in a better overall performance for the transmission than the original first MCS value obtained from table and UE signals. Given the first MCS value, the method of the invention will constantly observe the outcome of MCS value used in each transmission. Consequently, after a suitable number of transmissions, the Q-learning process may determine if the estimated first MCS value can be defined as conservative or aggressive based on these previous observations and how to modify it.

The aim of the proposed method is to predict the suitable MCS value (the second MCS value) for UL transmission which results in a high link throughput while simultaneously also preferably decreasing the BLER. By using Q-Learning, the method can automatically adapt to any changes and inaccuracies in the estimated SINR values. For the Q-Learning process, the possible MCS values are the states sₜ ∈S. Due to the fact that MCS values are discrete values, e.g., a finite sequence of integers, the preferred way to perform the Q-Learning process of the invention is by means of Q-tables.

As mentioned above, in addition to the first MCS value, another input to the Q-learning process is first data indicating whether the future transmission at time k is a first transmission or a retransmission. As an example, the first data may be a flag identifier: if the packet to be sent at transmission time interval k is not a previously sent packet, then the flag is set to one, else if it is being retransmitted, the flag is set to zero. This information enables the method to use two different Q-tables for the Q-Learning processes, where one is used in the case of new transmissions and the other is used in the case of retransmissions. This flag is used as an input to reflect the different properties of the received packets introduced by using HARQ procedure, as a retransmitted packet is more robust and has higher probability for detection when using HARQ procedure. Also, it reflects that the channel conditions under which previous transmissions took place. Therefore, the first data are used to “split” the Q-tables obtained using the Q-learning process in two, one for first transmissions and one for retransmissions. However, a single table could be used as well, introducing this variable in the single table.

Further, another input for the Q-learning process, still in step 502 of FIG. 5, is second data indicating whether a feedback acknowledgement, ACK/NACK, of a transmission that took place at transmission time interval k−1 is equal to ACK or NACK. There may be no correlation between the first data and the second data. These second data follow the UL HARQ Process ID, where each packet is assigned to a process ID, and retransmitted in case of unsuccessful transmission according to the process ID. For example, if the packets of HARQ process ID (0, 1, 2, and 3) are sent respectively, and only (0, 2, and 3) were successfully received, and the scheduler assigns the next transmission for the packet with HARQ processes ID (1). Therefore, the future transmission at time k is a retransmission and the first data should be selected as retransmission. However, the second data ACK/NACK refers to the latest transmission (i.e. the transmission at time k−1 which is this example was transmission having HARQ process ID (3)), and therefore this second data is ACK.

As an example, in this special case is first data=flag 0 (retransmission), second data=ACK. As detailed better below, this is the reason for preferably introducing a buffer, to sort each MCS, ACK/NACK, transmission/retransmission depending on its HARQ ID.

The Q-Learning process, from the input above detailed, outputs the second MSC value. This value may be sent to the UE as shown in step 503.

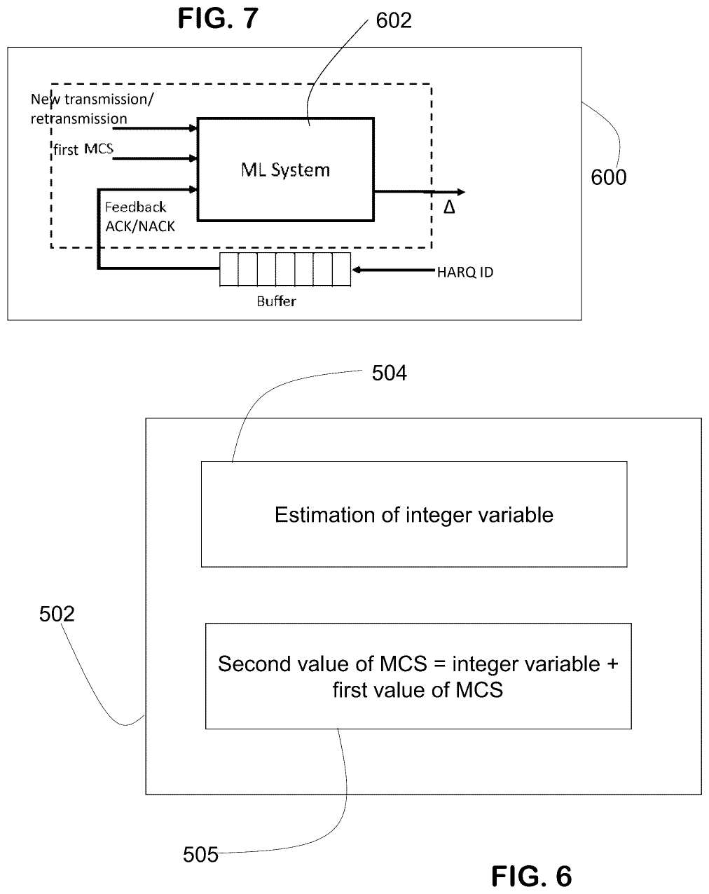

In embodiments, to simplify the calculation, the Q-learning process outputs an integer variable Δ, which, when added to the first value of the MCS, gives the estimation of the second value of the MCS to be used in the transmission at time interval k. Thus, the prediction of the second value of the MCS in step 502 is preferably obtained in two sub-steps: first a prediction of the integer variable Δ is obtained 504 via the Q-Learning process and then the Δ is added 505 to the first value of the MCS, as depicted in FIG. 6.

In embodiments, the method also includes selecting a maximum value for A; and predicting the value of Δ with the constraint that Δ is smaller or equal to the selected maximum value. In embodiments, the selected maximum value for Δ depends on a maximum acceptable value for the Block Error Rate, BLER, of the uplink transmission. Preferably, the maximum value for Δ is equal to 5; more preferably it is equal to 4. Preferably, the preferred second MCS value is calculated as follows:
Second MCS value=first MCS value±1 or
Second MCS value=first MCS value±2.

The integer variable Δ is preferably used to simplify the Q-learning process, so that faster results are obtained, and less computing power is required.

Preferably, in a Q-learning process, Q-table(s) are built. A Q-table comprises n columns, where n=number of actions. The Q-table further comprises m rows, where m=number of states.

In principle, in the method of the invention, the states are all the MCS possible values and thus there are actions for each single MCS value. In Q-learning technique, it is desirable to decrease the number of system actions as much as possible in order to reduce the size of the resulting Q-table (as shown above, the number of actions is equal to the column of the Q-table) and consequently the complexity of the system, as well as decreasing the exploration time needed to reach the optimal performance. Therefore, to avoid dedicating an action for each possible MCS value, the number of possible MCS states is “reduced”. A range of integer values is introduced, which is symmetric around the value of 0 and comprises both positive and negative constant values K. In other words, a range of all integer values comprised between-K and K is considered and called correction factor (CF), such as CF={−K . . . , −1, 0, 1, . . . , K}. The value of K determines the number of possible actions, and represent the threshold of the correction factor, and will be referred to as the correction factor margin (K). The value of K affects the value of Δ, which is consequently restricted as well. The second value of MCS predicted by the process can only be equal to first MCS value+Δ, where Δ is equal or smaller than K. Therefore, the maximum value of K is also the maximum value for Δ.

In embodiments, in the exploitation phase, adding CF might lead in some cases to a MCS value less than zero, or greater than the maximum MCS value. In the present embodiment, MCS tables in 5G as defined in 3GPP TS 38.214 having 32 MCS values from 0 to 31 are considered. However, the 28, 29, 30 and 31 values of MCS are reserved and thus only the MCS values from 0 to 27 are considered. Different number of MCS values may be considered as well. These impossible actions, in embodiments, are set to negative infinity in the Q-table, so the agent will avoid choosing them in future. While in the exploration phase, the random values that lead to impossible actions are discarded. Then the below condition is preferably applied when updating the Q-table:

$$newMCS = max [ 0 , min [ MCS + p ⋆ MCS , 27 ] ] .$$

Where p is an integer value in the CF range.

After the initialization, the Q-table needs to be updated to undergo a phase during which the MCS values are constantly updated. Preferably, in the present invention, there are two Q tables. A first Q table is used if the transmission that will take place at time k is a first transmission of a packet. A second Q table is used if the transmission that has to take place at time k is a retransmission of the packet already transmitted at least once.

In each of these Q tables, the update of the values set at time k=0 takes place using the following Bellman's equation,

$$New Q ( s , a ) = Q ( s , a ) + a * [ R ( s , a ) + γ * max ( {nextQ}^{′} ( {s}^{′} , {a}^{′} ) ) - Q ( s , a ) ] , \qquad ( Equation 1 )$$

where Q(s,a) is the Q value of action (a) at state (s), γ is the discount factor, R(s,a) is the reward for action (a) at state(s), and α is the learning rate, where 0≤α≤1 and weights the importance of the new experience compared to the old experience. In other words, the learning rate weights how quickly the agent abandons former information and replaces it with the newly observed experience, that is, if α=1, the new Q-value will completely replace the former value and, therefore, the agent is not concerned with keeping older observations.

In the present invention the values of Q(s,a) in the table are the MCS values.

In embodiments, the method chooses a reward function for the Q-Learning process that enables the system to achieve the optimal goal based on positive and negative feedback of previous actions. In embodiments, predicting a second value of the MCS for the transmission at transmission time k by using a Q-learning process comprises selecting a reward function for the Q-learning process which depends on a Transfer Block Size, TBS, of a transmission at transmission time j and on the ACK/NACK value of the transmission at transmission time j.

In embodiments, the reward function of a certain action (a) at a certain state(s) can be calculated as below:

$$R ( s , a ) = T B S * A C K$$

where TBS is the Transfer Block Size of the transmitted subframe, and ACK is the second data, that is, the acknowledgment flag. TBS represents the number of useful bits transmitted using the chosen MCS value. The TBS is used to reflect the usefulness of the chosen MCS value. Hence, TBS is preferably calculated assuming one-layer UL channel with full buffer state, so there are no padded bits that might influence the TBS value and therefore the reward function. The ACK is an indicator of the success of previous action, that is, if the previous transmission has failed, the ACK will be equal to zero or NACK, and therefore the method will not gain any reward from current action.

The TBS is not an additional input to the Q-learning process, due to the fact that the TBS is obtained from the corresponding MCS. Thus to know the TBS at transmission time j, the MCS at transmission time j is needed.

The system will always keep updating the Q-values according to the previous decision and its reward. This allows the system to adapt to any changes in the environment, and always seeks to improve performance.

For example, the reward function for the action of adding 4 to a MCS value, from a starting MCS value to an updated MCS value=starting MCS value+4, is equal to the value of TBS (if the second data=ACK) or to the value of zero 0 (if the second data=NACK) of the j-transmission which takes place using the updated MCS value. Both TBS and ACK/NACK are of the same j-transmission, that is, the reward function is calculated multiplying the TBS of the transmission that takes place at time j by the ACK/NACK of the same transmission at time j. In the above, the convention ACK/NACK=ACK=1 and ACXK/NACK=NACK=0 is used.

In embodiments, the reward function is equal to zero if the ACK/NACK value is equal to NACK. As shown above, if the ACK/NACK value is equal to NACK; the reward function is equal to zero. Indeed, if the transmission is not received, there is no reward for such an action.

According to embodiments, a maximum acceptable value for the Block Error Rate, BLER, of the uplink transmission is selected, and predicting a second value of the MCS for the transmission at transmission time k by using a Q-learning process includes: selecting a minimum value for an exploration rate of the Q-learning process based on the maximum acceptable value for the BLER of the uplink transmission.

Before an action is executed, the action selection policy (exploration or exploitation) is decided, which can be controlled by the value of the exploration rate, which is called epsilon. As agent begins the learning, random actions are preferred to explore more paths. But as the agent gets better, the Q-function converges to more consistent Q-values. In this case, it is preferred that the agent exploit paths with highest Q-value, i.e., that it takes greedy actions. This is where epsilon comes in. The agent takes random actions for probability ε and greedy action for probability (1−ε). The policy determines whether the action selection follows a random process (exploration), or if it will exploit the previous experience (exploitation). Epsilon value decreases progressively to decrease the exploration events in the expense of increasing exploitation, until it reaches a minimum value. In embodiments, epsilon decreases linearly with each iteration, until reaching a minimum value. In an example, starting with epsilon=1, then after each iteration:

$$epsilon = epsilon - X .$$

For example, in the following simulation results, X=0.01 and final epsilon value is 0.05 (after almost 95 iterations).

The method preferably selects a minimum value for epsilon based on the maximum acceptable value for the BLER of the uplink transmission. As an example, if it is decided that the BLER is below the constraint value of BLER=10%, then the chosen value for epsilon is 0.05. This means that the random exploration action occurs once every 20 iterations to look for a better reward.

Coming back to formula (1), as mentioned the learning rate ranges (α) is a value between [0,1]. As α increases, the importance of new information against old information is increased. In embodiments, the learning rate is chosen relatively high (α>0.5, more preferably α>0.75 and even more preferably α=0.85), to allow the system to quickly adapt to the changes occurring in the channel. Using high learning rate also decreases the required time to reach its optimized performance.

In embodiments, predicting a second value of the MCS for the transmission at transmission time k by using a Q-learning process comprises: selecting a discount factor equal to zero. The discount factor gamma γ of formula 1 is a value that ranges between [0,1], and as the discount rate increases, the highly the system evaluates the long-term rewards. However, in LA, the current MCS value have no direct influence on the next MCS value, as it mainly depends on the variation of the channel conditions.

Therefore, the discount rate is in embodiments set equal to zero.

In the training of the method, in embodiments, an action is chosen. The random policy is quite straightforward, where the action is randomly selected from the set of all actions. On the other hand, the exploitation process depends on a greedy policy, by choosing the action that leads to the highest Q-value. The method then observes the outcome of the performed action at that certain state, and calculates the reward depending on the predefined reward function R(s,a).

After a suitable number of iterations, the Q-table is optimized. The method chooses the optimal action that leads to the highest expected cumulative reward, by utilizing the obtained Q-table, and selecting the action that corresponds to the maximum Q-value.

The optimized Q-tables (one for transmission and the other for retransmission) are used to estimate the second MCS value. The tables are constantly updated.

In FIG. 7, an embodiment of a network node 600 which can implement the method of the invention is depicted. Network node 600 may be similar to network node 110 of FIG. 1 or network node 300 of FIG. 3 or network node 400 of FIG. 4. Network node 600 includes a processing circuit (ML system) 602 which receives as inputs the first MCS, the first data, the second data, and outputs a value of Δ, which, summed or subtracted to the first MCS, gives the second MCS value.

The method of the invention may also be implemented by the network node 110 of FIG. 1, or the network node 300 of FIG. 3. For example, with reference to FIG. 3, an example node 300 which may implement the methods described herein (e.g. the method as illustrated in and described with reference to FIG. 5), according to examples of the present disclosure, for example on receipt of suitable instructions from a computer program (not shown). Referring to FIG. 3, the node 300 comprises a processor or processing circuitry 302, and may comprise a memory 304 and/or interfaces 306. The processing circuitry 302 is operable to perform some or all of the steps of the methods described herein (e.g. the method as discussed above with reference to FIG. 5). The memory 304 may contain instructions executable by the processing circuitry 302 such that the orchestrator node 300 is operable to perform some or all of the steps of the methods described herein (e.g. the method as discussed above with reference to FIG. 5). The instructions may also include instructions for executing one or more telecommunications and/or data communications protocols. The instructions may be stored in the form of the computer program.

In some embodiments, the node functionality described herein can be performed by hardware. Thus, in some embodiments, the network node described herein can be a hardware entity. However, it will also be understood that optionally at least part or all of the network node functionality described herein can be virtualised. For example, the functions performed by the node 300 herein can be implemented in software running on generic hardware that is configured to orchestrate the orchestrator node functionality described herein. Thus, in some embodiments, the node 300 described herein can be a virtual entity. In some embodiments, at least part or all of the orchestrator node functionality described herein may be performed in a network enabled cloud. Thus, the method described herein can be realised as a cloud implementation according to some embodiments. The network node functionality described herein may all be at the same location or at least some of the orchestrator node functionality may be distributed, e.g. the network node functionality may be performed by one or more different entities.

In the further example of network node operative according to the invention and depicted in FIG. 7, the network node 600 receives as input to processing circuit 602 the first MCS, first data and second data. Furthermore, the processing circuit may output the second MCS value. Preferably, the network node 600 comprises a buffer 604. Buffer 604 is used to combine each HARQ process ID and its ACK/NACK, since multiple transmissions can be performed before receiving their ACK/NACK. Indeed, for a plurality of transmissions at transmission time intervals k-p, . . . , k−1 the corresponding ACK/NACK may not be received in the same order in which the transmissions take place. The buffer is then used to associating to a HARQ process ID of each of the p transmissions of the plurality their corresponding ACK/NACK value.

In embodiments, the uplink transmission is in the frequency range of 24.25 GHZ and 52.6 GHZ. The uplink transmission is preferably in the millimeters range.

There is also provided a computer program comprising instructions which, when executed by processing circuitry (such as the processing circuitry 302 of the network node 300 described herein), cause the processing circuitry to perform at least part of the method described herein. There is provided a computer program product, embodied on a non-transitory machine-readable medium, comprising instructions which are executable by processing circuitry (such as the processing circuitry 302 of the orchestrator node 300 described herein) to cause the processing circuitry to perform at least part of the method described herein. There is provided a computer program product comprising a carrier containing instructions for causing processing circuitry (such as the processing circuitry 302 of the network node 300 described herein) to perform at least part of the method described herein. In some embodiments, the carrier can be any one of an electronic signal, an optical signal, an electromagnetic signal, an electrical signal, a radio signal, a microwave signal, or a computer-readable storage medium.

It will be understood that at least some or all of the method steps described herein can be automated in some embodiments. That is, in some embodiments, at least some or all of the method steps described herein can be performed automatically. The method described herein can be a computer-implemented method.

Therefore, as described herein, there is provided an advantageous technique for a link adaptation of a uplink transmission using a Q-learning process. The method can improve transmission performance, particularly, in terms of throughput and BLER.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

### Example 1

Simulations have been performed to show the improvement given by the invention.

The parameters used in the simulation are given below in Table 1.

TABLE 1

| Parameter | Value | |
|---|---|---|
| Scenario | 5G NR Network with full | |
| | buffer user | |
| Simulatin Period | 10 | s |
| User Speed | Average Walking speed | |
| | (1.3 mps) | |
| Carrier Frequency | 28 | GHz |
| Bandwidth | 200 | MHz |
| No. Of Users | 1 | |
| Cell Radius | 100 | m |
| BS Antenna Height | 25.0 | |
| UE Antenna Height | 1.5 | m |

| | |
|---|---|
| Antenna Tilt Angle | 15 |

The aim of LA procedure is to maximize the throughput while maintaining BLER below 10%. Therefore, to evaluate the scheduler decisions for the UL LA procedure, these two main outputs should be taken in consideration.

After running the simulation, UL throughput and BLER were obtained for 20 different random seeds (the “random seeds” are used to initialize the random generator, so that, each seed creates different random numbers used in the code, e.g., noise) and using 15 different value of K in the correction factor CF. Thus, to facilitate the demonstration of these results, all seed's outputs were averaged. In relevance to this matter, Matlab was used to average the outputs, and present the obtained results in clear figures.

The integer value K can limit the actions of the ML system and therefore it's interventions on the MCS value. If K is set to zero, the ML algorithm will be unable to modify the MCS value, as the highest CF possible will be zero, while having K equal to 27 allows the ML system to have full control on the LA procedure, since the Correction Factor (CF)={−K . . . , −1, 0, 1, . . . , K}.

By increasing K, the number of actions is increased, leading to higher complexity and larger Q-tables. Therefore, setting K to a small number can be more reasonable, especially that OLLA is expected to correct the estimated MCS value predicted by ILLA. In addition, by using lower K value, it is expected to result in a better performance, due to the decrement in exploration time.

The 15 values of K used in this simulation are [0 (non-ML), 1, 2, 3, 4, 5, 6, 7, 8, 9, 10, 15, 20, 24, 27]. The simulation is run for each value with the period of 10 seconds and for 20 different random seed.

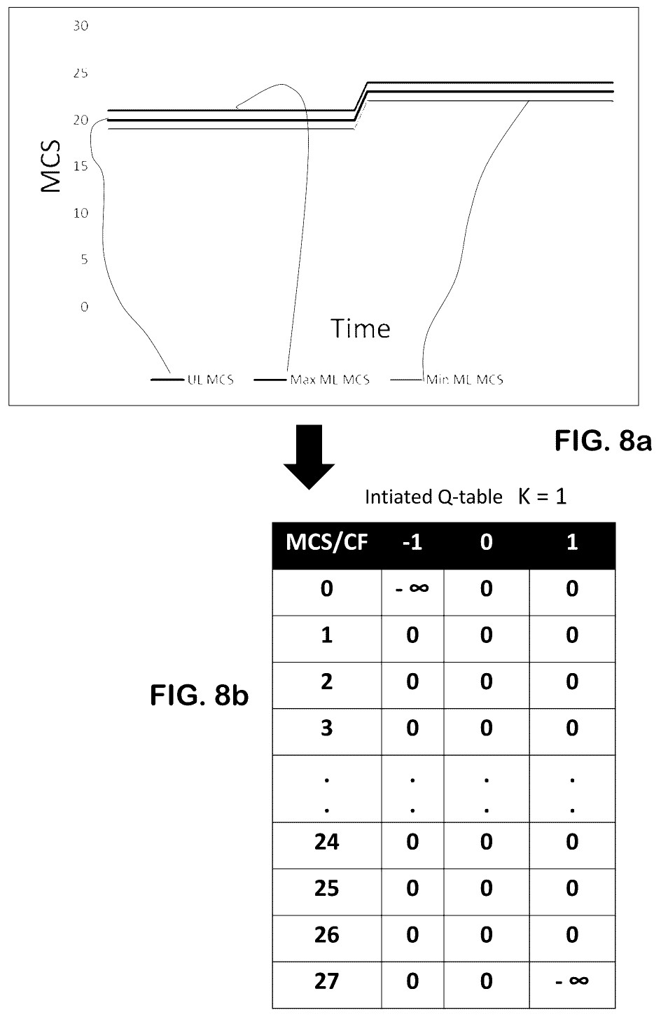

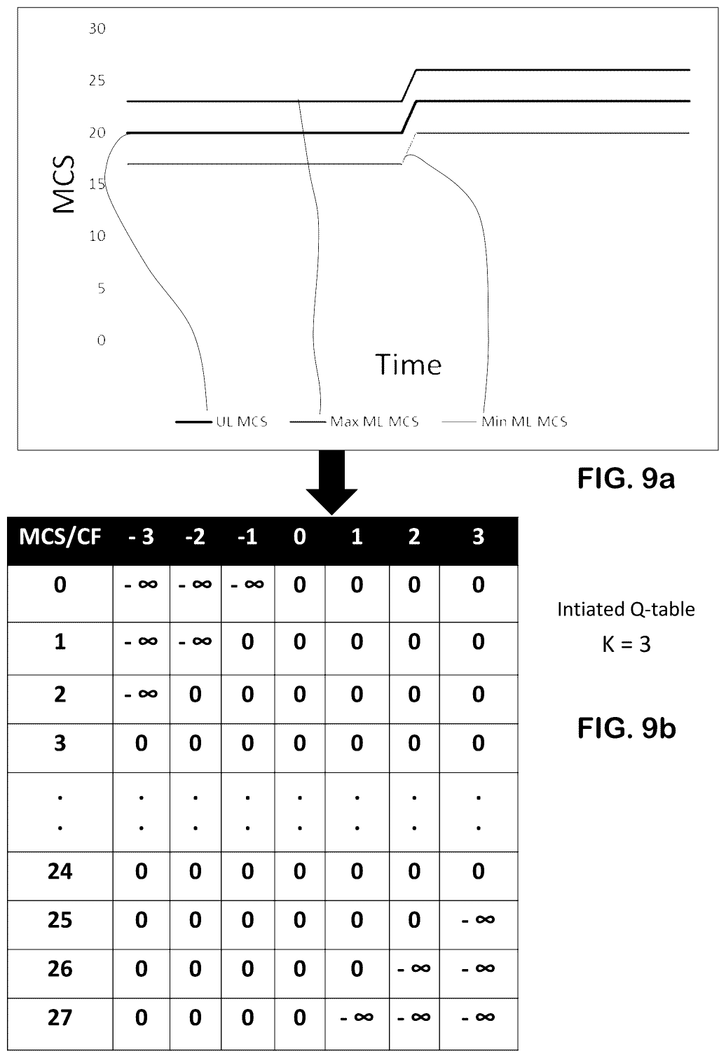

In FIGS. 8a and 8b a value of K=1 is used, while in FIGS. 9a and 9b a value of K=3 is used. FIGS. 8b and 9b represent the initialized Q-tables (it is to be understood that for each selected K value, there are two Q tables, one for transmission and the other for re-transmission. However, in FIGS. 8b and 9b only one of the two tables is shown) for K=1 and K=3, respectively. As visible from table of FIG. 8b, in case of K=1 then CF=−1, 0, 1 and thus the MCS can modify its value of +1 or stay unchanged. This is depicted in the graph of FIG. 8a, where the value of MCS is shown vs time. The first MCS value of the uplink transmission can vary only from a minimum value which is equal to first MCS value −1 to a maximum value which is equal to first MCS value+1. In the case of K=3, the states and action in the Q table of FIG. 9b can be many more, because, in case of K=3, then CF=−3, −2, −1, 0, 1, 2, 3 and thus the MCS can modify its value of ±1, ±2 or ±3 (or stay unchanged). This is depicted in the graph of FIG. 9a, where the MCS is shown vs time. The first MCS value of the uplink transmission can vary from a minimum value which is equal to first MCS value −3 to a maximum value which is equal to first MCS value +3.

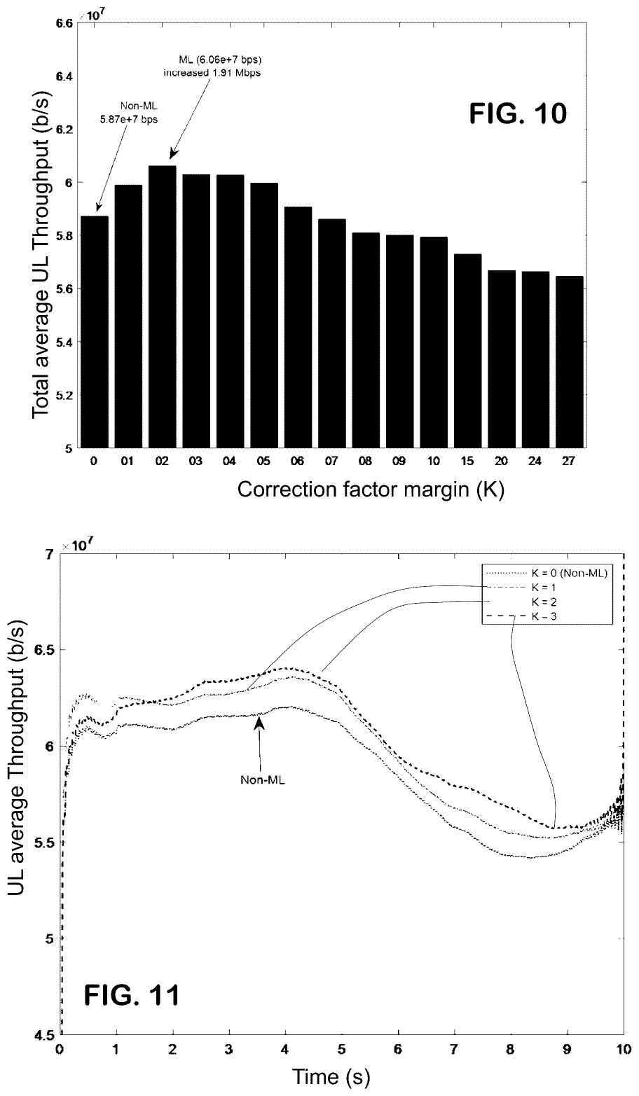

As mentioned earlier, the output of 20 different seeds is averaged to get a reliable result from the simulation. The mean of all the 10 seconds period is calculated, in accordance with the UL user throughput. FIG. 10 shows the results for the total averaged UL throughput for 15 different K values over the simulation period. As clear from FIG. 10, the throughput showed an improvement using K={1, 2, 3, 4, 5} when compared to the case where the method of the invention is not used (the case where the method of the invention is not used is indicated as “non-ML” in FIG. 10). The performance keeps degrading as K increases. This can be expected, since K value increases the possible actions, and lead to decreasing the dependence on the ILLA. The optimal K value (K=2) increases the UL user throughput by 1.9 Mbps compared to the non-ML throughput.

In FIG. 11, multiple graphs are plotted showing the total averaged UL throughput vs time for the value of K=1, 2 and 3 and in addition for the UL throughput using the first MCS value (i.e., without using the method of the invention, indicated as “non-ML” in the graph), over the duration of 10 seconds. The result illustrates that the K values of 1, 2 and 3 result in an increment on UL user throughput over the entire time period examined. Indeed, for all the examined K, the throughput curve is above the curve where the method of the invention is not applied (called non-ML curve in the plot of FIG. 11) during all the 10 seconds duration. The optimal performance is achieved in the case of using K=2, while K=1 shows less improvement than K=2.

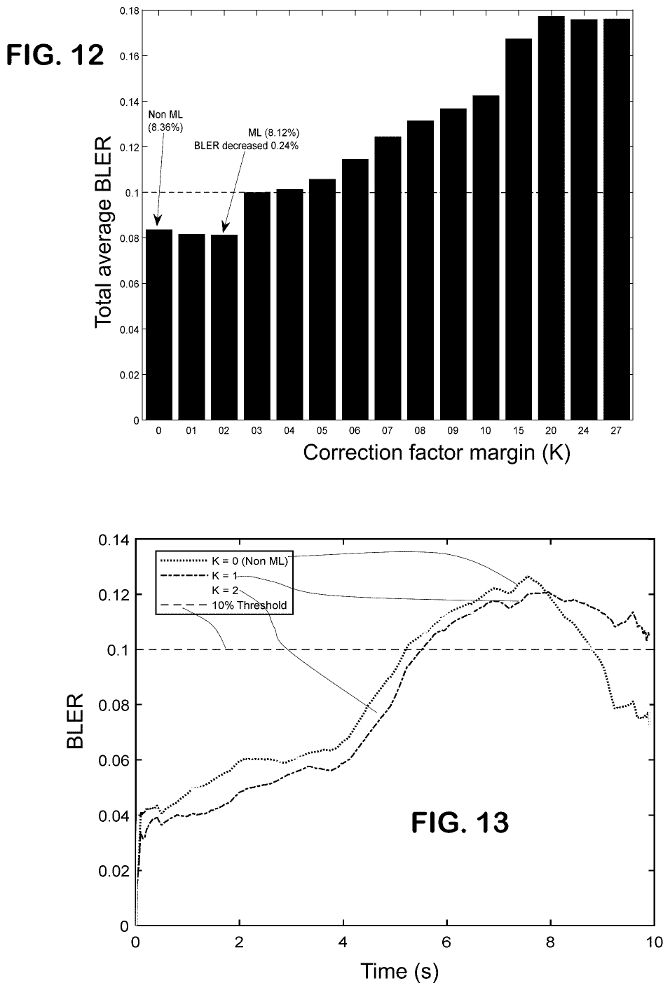

In FIG. 12, UL BLER is averaged for all 20 used seeds, then the mean was calculated over all the simulation period for 15 different K value. As visible in FIG. 12, two K values (1 and 2) give an enhanced performance compared to the situation where the method of the invention is not use (called non-ML). For K=1 and K=2 the BLER decreases in comparison to the non-ML case.

Furthermore, despite the fact that BLER for K=3 is increased with respect to the case in which the method of the invention is not used, it is still within the selected constraint on the BLER (It is preferred to have BLER<10%, in this case being exactly 10%). However, all other values of K fail to achieve this constraint, and kept degrading as K increased, with comparable performance to the obtained UL throughput.

FIG. 13 shows the BLER curves obtained for those K values that improve the system performance vs time. The BLER obtained without using the method of the invention is also plotted (K=0, non-ML). Differently from the previous situation, there is no “dominant” curve that is always above the others, but the various plots for different K intersect each other.

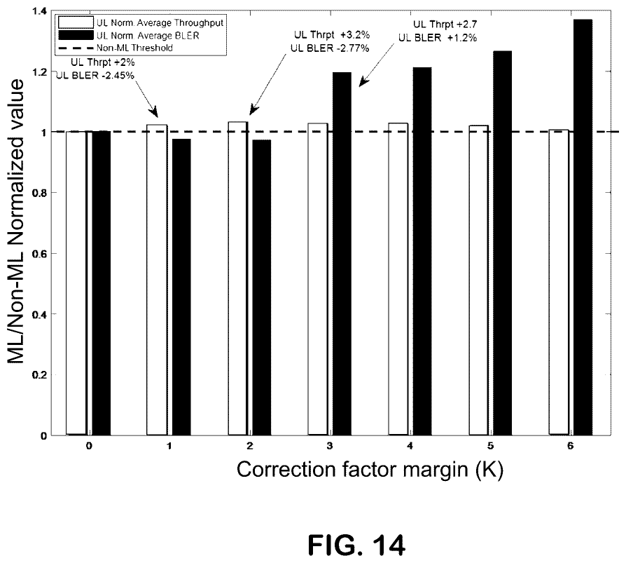

The results obtained for BLER and throughput are summarized in FIG. 14. Only the K values that resulted in an improvement in BLER or in throughout with respect to the case in which the method of the invention is not used are considered. A normalization process is performed, since the throughput is measured in bps, while the BLER only ranges between 0 and 1. Therefore, the value obtained without the use of the method of the invention is considered as the normalization factor for both the throughput (5.87e+7 bps) and BLER (8.36%). As a result, it can be seen that two values of K (1 and 2) achieved better performance in both aspects, BLER and throughput. Furthermore, the best improvement in both aspects was achieved when K=2, and therefore it can be considered as the optimal K value in this specific scenario used as an example.

1. A method for performing a link adaptation in an uplink transmission between a user equipment, UE, and a network node in a telecommunication network (102), the method comprising:
obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and
predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

2. The method according to claim 1, comprising:
sending information on the predicted second value of the MCS to the UE.

3. The method according to claim 1, wherein obtaining a first value of the MCS, includes:
estimating the SINR on the basis of reference signals transmitted by the UE to the network node.

4. The method according to claim 1, wherein obtaining a first value of the MCS, includes:
obtaining the first value of the MCS from look-up tables disclosed in the standard 3GPP TS 38.214.

5. The method according to claim 1, wherein predicting a second value of the MCS for the transmission at transmission time k by using a Q-learning process comprises predicting the value of a variable Δ, wherein Δ is an integer, and the second value for MCS is equal to the sum of the first value of the MCS and Δ or to the difference between the first value of the MCS and Δ.

6. The method according to claim 5, comprising:
selecting a maximum value for Δ; and
predicting the value of Δ with the constraint that Δ is smaller or equal to the selected maximum value.

7. The method according to claim 6, wherein the selected maximum value for Δ depends on a maximum acceptable value for the Block Error Rate, BLER, of the uplink transmission.

8. The method according to claim 7, wherein the maximum value for Δ is equal to 5.

9. The method according to claim 1, wherein predicting a second value of the MCS for the transmission at transmission time k by using a Q-learning process comprises selecting a reward function for the Q-learning process which depends on a Transfer Block Size, TBS, of a transmission at transmission time j and on the ACK/NACK value of the transmission at transmission time interval j.

10. The method according to claim 9, wherein the reward function is equal to zero if the ACK/NACK value is equal to NACK.

11. The method according to claim 1, including:
obtaining the first data or the second data by obtaining a Hybrid automatic repeat request, HARQ, of a transmission that took place at transmission time interval k−1.

12. The method according to claim 1, comprising selecting a maximum acceptable value for the Block Error Rate, BLER, of the uplink transmission, and wherein predicting a second value of the MCS for the transmission at transmission time k by using a Q-learning process includes:
selecting a minimum value for an exploration rate of the Q-learning process based on the maximum acceptable value for the BLER of the uplink transmission.

13. The method according to claim 1, comprising, for a plurality of p transmissions at transmission time intervals k-p, . . . , k−1:
associating to a HARQ process ID of each of the p transmissions of the plurality their corresponding ACK/NACK value.

14. The method according to claim 1, wherein predicting a second value of the MCS for the transmission at transmission time k by using a Q-learning process comprises:
selecting a discount factor equal to zero.

15. The method according to claim 1, wherein the uplink transmission is in the frequency range of 24.25 GHZ and 52.6 GHZ.

16. A network node performing a link adaptation in an uplink transmission with a user equipment, UE, in a telecommunication network, the network node comprising:
a processing circuitry; and
a memory coupled with the processing circuitry, wherein the memory includes instructions that when executed by the processing circuitry causes the network node to perform operations, the operations comprising:
obtaining a first value of a Modulation and Coding Scheme, MCS, for a future transmission at transmission time interval k in the uplink transmission, the first value of MCS being determined on the basis of a Signal to Interference and Noise Ratio, SINR, estimated by the network node for the future transmission at transmission time interval k; and
predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

17. The network node of claim 16, wherein the operations further comprise sending information on the predicted second value of the MCS to the UE.

18.-19. (canceled)

20. The network node according to claim 16, wherein the network node comprises an access network node.

21.-23. (canceled)

24. A computer program product comprising a non-transitory storage medium including program code to be executed by processing circuitry of a network node operating in a telecommunications network, whereby execution of the program code causes the network node to perform operations, the operations comprising:
obtaining a first value of a Modulation and Coding Scheme, MCS, for a future transmission at transmission time interval k in the uplink transmission, the first value of MCS being determined on the basis of a Signal to Interference and Noise Ratio, SIRN, estimated by the network node for the future transmission at transmission time interval k; and
predicting a second value of the MCS for the future transmission at transmission time k by using a Q-learning process having as input the first value of MCS, first data indicating whether the future transmission at transmission time k is a first transmission or a retransmission, and second data indicating whether a feedback acknowledgement, ACK/NACK, of a transmission that took place at transmission time interval k−1 is equal to ACK or NACK.

25. The computer program product according to claim 24, whereby the operations further comprise sending information on the predicted second value of the MCS to a user equipment.
